(19) United States
(12) Patent Application Publication
(10) Pub. No.: US 2025/0305950 A1
(43) Pub. Date: Oct. 2, 2025

(54) Combined Ellipsometry and Scatterometry

(71) Applicant: KLA CORPORATION, Milpitas, CA (US)

(72) Inventors: Boxue CHEN, San Jose, CA (US); Isvar CORDOVA, Sunnyvale, CA (US); Qiang ZHAO, Milpitas, CA (US); Jongjin KIM, San Jose, CA (US); Chao CHANG, San Jose, CA (US); Sergey ZALUBOVSKY, San Jose, CA (US)

(21) Appl. No.: 19/088,899

(22) Filed: Mar. 24, 2025

Related U.S. Application Data
(60) Provisional application No. 63/570,812, filed on Mar. 28, 2024.

(51) Int. Cl. G01N 21/47; G01N 21/21; G01N 21/55

(52) U.S. Cl. CPC G01N 21/47; G01N 21/211; G01N 21/55; G01N 2021/4792

(57) ABSTRACT

A system includes a radiation source that generates radiation having at least one wavelength from 0.1 to 100 nm. One or more rotating elements change polarization of the radiation and/or relative phase between two polarizations of the radiation. A stage is configured to hold a workpiece in a path of the radiation. At least one detector receives spectral reflection and scattering radiation from the workpiece.

### CROSS-REFERENCE TO RELATED APPLICATIONS

This application claims priority to the provisional patent application filed Mar. 28, 2024 and assigned U.S. App. No. 63/570,812, the disclosure of which is hereby incorporated by reference.

### FIELD OF THE DISCLOSURE

This disclosure relates to metrology of workpieces, such as semiconductor wafers.

### BACKGROUND OF THE DISCLOSURE

Evolution of the semiconductor manufacturing industry is placing greater demands on yield management and, in particular, on metrology and inspection systems. Critical dimensions continue to shrink, yet the industry needs to decrease time for achieving high-yield, high-value production. Minimizing the total time from detecting a yield problem to fixing it maximizes the return-on-investment for a semiconductor manufacturer.

Fabricating semiconductor devices, such as logic and memory devices, typically includes processing a semiconductor wafer or other workpiece using a large number of fabrication processes to form various features and multiple levels of the semiconductor devices. For example, lithography is a semiconductor fabrication process that involves transferring a pattern from a reticle to a photoresist arranged on a semiconductor wafer. Additional examples of semiconductor fabrication processes include, but are not limited to, chemical-mechanical polishing (CMP), etching, deposition, and ion implantation. An arrangement of multiple semiconductor devices fabricated on a single semiconductor wafer may be separated into individual semiconductor devices.

Metrology processes are used at various steps during semiconductor manufacturing to monitor and control the process. Metrology processes are different than inspection processes in that, unlike inspection processes in which defects are detected on workpieces, metrology processes are used to measure one or more characteristics of the workpieces that cannot be determined using existing inspection tools. Metrology processes can be used to measure one or more characteristics of workpieces such that the performance of a process can be determined from the one or more characteristics. For example, metrology processes can measure a dimension (e.g., line width, thickness, etc.) of features formed on the workpieces during the process. In addition, if the one or more characteristics of the workpieces are unacceptable (e.g., out of a predetermined range for the characteristic(s)), the measurements of the one or more characteristics of the workpieces may be used to alter one or more parameters of the process such that additional workpieces manufactured by the process have acceptable characteristic(s).

Scatterometry or reflectometry have been used for metrology applications. However, both scatterometry and reflectometry used reflective intensity or scattered intensity for measurements. Phase information, which included structural XY plane geometry information across a workpiece surface, was lost. An example of a previous system for scatterometry is shown in FIG. 1. The detector in FIG. 1 is used for all orders (−1st, 0th, +1st). There also was no attempt to achieve ellipsometry, which used only reflective intensity or scattered intensity for measurements. Scattering information was lost for ellipsometry. An example of a previous system for ellipsometry for visible-infrared wavelengths is shown in FIG. 2. The example in FIG. 2 does not include scattering orders. 0th order relative phase information (e.g., complex rs/rp, or partial/full 16 Mueller elements) may be recorded, but not high scattering information with its structural asymmetry information.

Thus, either phase information or scattering information was lost in previous systems. Both phase information and scattering information include valuable information. For example, scattering information includes information about structure asymmetry, such as overlay, tilt, pitch walk, or aperiodicity. Phase information can be used to resolve XY-plane features such as critical dimension. Improved systems and techniques are needed.

### BRIEF SUMMARY OF THE DISCLOSURE

A system is provided in a first embodiment. A system includes a radiation source that generates radiation having at least one wavelength from 0.1 to 100 nm. One or more rotating elements are configured to change polarization of the radiation and/or relative phase between two polarizations of the radiation. A stage is configured to hold a workpiece in a path of the radiation. At least one detector receives spectral reflection and scattering radiation from the workpiece. The radiation may include a wavelength at 13.5 nm.

In an instance, the radiation source is a narrow-band source. The narrow-band source may be a wide numerical aperture plasma source or a narrow numerical aperture laser-like source. In another instance, the radiation source is a broadband source.

The rotating elements may include a reflective polarizer. The reflective polarizer may be disposed in a path of the spectral reflection between the workpiece on the stage and the detector.

The rotating elements may include a transmissive phase retarder or a reflective phase retarder.

The system can include a rotating polarizer in the path of the radiation or a path of the scattering radiation.

The system also can include a rotating compensator and a fixed analyzer in a path of the scattering radiation. In an instance, the system includes a fixed polarizer and a rotating compensator in the path of the radiation.

The system can includes a fixed reflective polarizer in the path of the scattering radiation.

The system can include a processor in electronic communication with the detector. The processor can be configured to determine asymmetry-related critical dimensions from signals of the detector, such as the scattering radiation. The processor also can be configured to determine XY-plan features from the polarization states. The processor can be further configured to determine critical parameters of the workpiece from signals of the detector using machine learning or a regression engine. The regression engine may be configured to match the signals against simulated spectra at the critical parameters.

The system can include a plurality of the detectors to receive the spectral reflection and/or the scattering radiation.

The system can include an ellipsoidal mirror disposed in a path of the spectral reflection.

### DESCRIPTION OF THE DRAWINGS

For a fuller understanding of the nature and objects of the disclosure, reference should be made to the following detailed description taken in conjunction with the accompanying drawings, in which:

FIG. 1 is a diagram of a previous system for scatterometry;

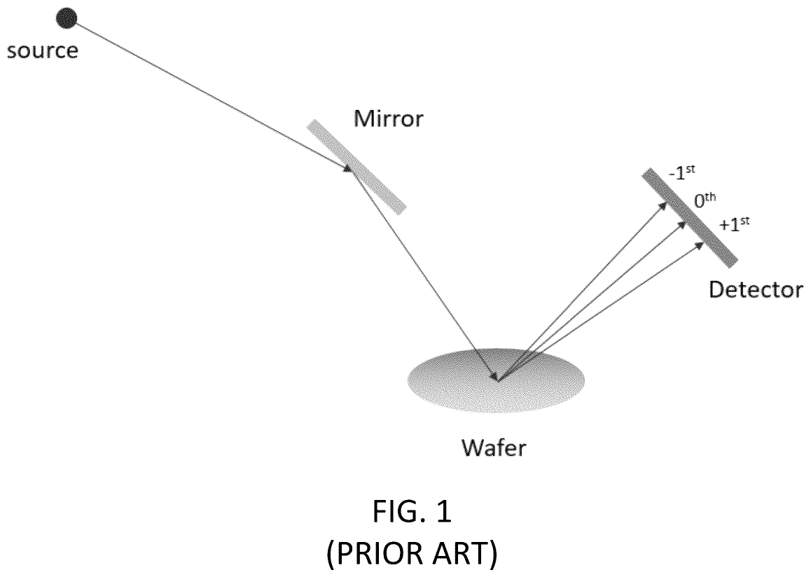

FIG. 2 is a diagram of a previous system for dual rotating compensator ellipsometry;

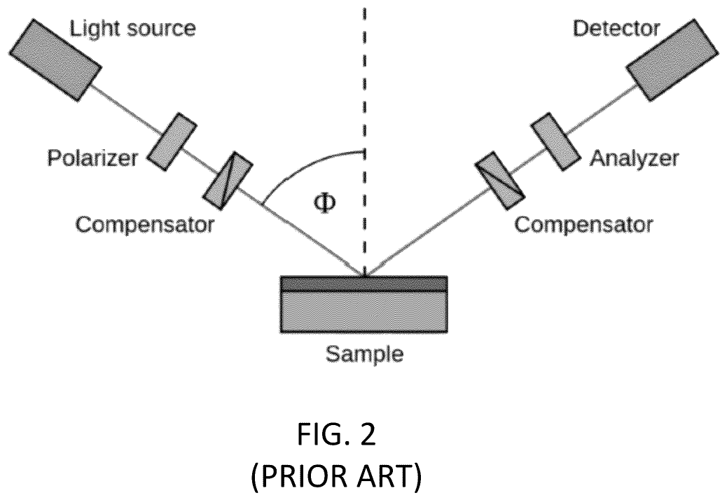

FIG. 3 is a chart showing performance of a gold film polarizer;

FIG. 4 is a chart showing performance of a silicon/molybdenum multilayer polarizer;

FIG. 5 is an exemplary single-reflection rotating polarizer used with a large numerical aperture plasma source;

FIG. 6 is an exemplary triple reflection rotating polarizer;

FIG. 7 is an exemplary quadruple reflection rotating polarizer;

FIG. 8 is a diagram of an embodiment of a low numerical aperture rotating polarizer in a system for ellipsometric scatterometry;

FIG. 9 is a diagram of an embodiment of a wide numerical aperture rotating polarizer in a system for ellipsometric scatterometry;

FIG. 10 is a diagram of an embodiment of a rotating analyzer in a system for ellipsometric scatterometry;

FIG. 11 is a diagram of an embodiment of a rotating compensator in a system for ellipsometric scatterometry;

FIG. 12 is a diagram of an embodiment of a dual rotating compensator in a system for ellipsometric scatterometry;

FIG. 13 is a diagram of an embodiment of a broadband rotating polarizer in a system for ellipsometric scatterometry; and

FIG. 14 is a diagram of an embodiment of a broadband rotating polarizer in a system for ellipsometric scatterometry with a focusing mirror to control the scattering order's polarization before incidence on the first detector.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

Embodiments disclosed herein combine ellipsometry and scatterometry to provide the benefits of relative phase signal and scattering signal. While conventional architectures only obtain ellipsometry or scatterometry, the embodiments disclosed herein provide both scattering information and relative phase information. Scattering information contains structure asymmetry, such as tilt, overlay, pitch walk, local critical dimension uniformity, and/or aperiodicity. Phase information is used to determine XY-plane features, such as critical dimension (CD), recess amount, or side-wall angle. The combination of two signal channels does not add any additional computation cost to the metrology system. This combination can be particularly useful for decoupling overlay, tilt, pitch walk, and/or randomness from critical dimensional and/or sidewall angle. In particular, metrology of silicon-based semiconductor samples when crossing a silicon edge at 99.2 cV or actinic metrology of EUV phase shift masks (˜91.8 eV) may be improved.

In an embodiment, the system includes a radiation source that generates radiation having at least one wavelength from 0.1 nm to 100 nm (i.e., equivalent to 10 eV to 10 keV). One or more wavelengths may be emitted. For example, the radiation source may emit a 3 nm wavelength. The radiation source may be a narrow-band source or a broadband source. The narrow-band source may be a wide numerical aperture plasma source or a narrow numerical aperture laser-like source. For example, a laser produced plasma (LPP) source may be used, which provides radiation that covers a wide range of numerical apertures. In another example, an x-ray tube (rotating solid anode or static solid anode or liquid metal jet) may be used, which provides radiation at certain emission lines that covers a wide range of numerical apertures. In another example, a high harmonic generator (HHG) source may be used, which has a limited range of numerical apertures.

In an instance, a broadband source can use a wavelength that crosses one or more silicon absorption edges (1.84 KeV, 148.7 cV, 99.2 cV, etc.) to obtain more sensitivity to silicon-based workpieces. The broadband source may be narrowed by a wavelength bandpass filter.

In another instance, the radiation may include a wavelength at 13.5 nm. A 13.5 nm wavelength can be used for actinic metrology on an EUV mask and/or pellicle. Consequently, the system can be used for metrology of phase shift mask because it provides information of both mask 3D effect and wave effect.

Radiation from 1 nm to 30 nm may be used for semiconductor applications. The wavelength may be less than the structure pitch (e.g., 30 nm to 10 μm) to receive enough orders for scatterometry. Structures may be insensitive to polarization for very small wavelengths.

A stage is configured to hold a workpiece (e.g., a semiconductor wafer) in a path of the radiation. At least one detector receives spectral reflection and scattering radiation from the workpiece. The spectral reflection and scattering radiation occur when the radiation is directed onto the surface of the workpiece. The spectral reflection can help characterize how much radiation is reflected from the surface of the workpiece at different wavelengths.

One or more rotating elements are configured to change polarization of the radiation and/or relative phase between two polarizations of the radiation. The rotating element can include a reflective polarizer, such as a reflective polarizer that is disposed in a path of the spectral reflection between the workpiece on the stage and the detector. The reflective polarizer can include a multi-layer mirror, one or more single-layer films, or other components.

Traditional scatterometry relies on a transmissive polarizer or retarder. The retarder may transmit radiation and modify its polarization state. However, a transmissive polarizer or retarder may not provide the desired performance at all wavelength ranges used for metrology, which makes it challenging to design for scatterometry. In an embodiment, multiple reflective mirrors can be used in a reflective polarizer and phase retarder. Depending on the actual wavelength, different types of reflective mirrors can be used. For example, Au/Pt coatings can be used for photons<40 eV. Muscovite mica crystal can be used for photons of approximately 1 keV. Multi-layer mirrors can be used for photons from 40 eV to 1 keV. Below is a table of exemplary multi-layer configurations and corresponding operation wavelengths.

| Material stack | E range (eV) |
|---|---|
| Si/Mo | <100 |
| Mo/Y | 100-140 |
| B₄C/La | 150-180 |
| Cr/C | 190-280 |
| Cr/Sc | 290-390 |
| Cr/Ti | 400-450 |
| Cr/V | 460-510 |
| B₄C/W | >510 |

Some multi-layer mirrors are designed for narrow-band applications. However, aperiodicity or an inter-layer or barrier layer (e.g., Si/MoSi₂/Mo/MoSi₂, Si/Mo₂C/Mo/Mo₂C, Si/B₄C/Mo, etc.) can be introduced to provide a broadband reflective mirror. The inter-layer or barrier layer can be introduced by repeated deposits of quadlayers, such as Si/MoSi₂/Mo/MoSi₂ or other materials.

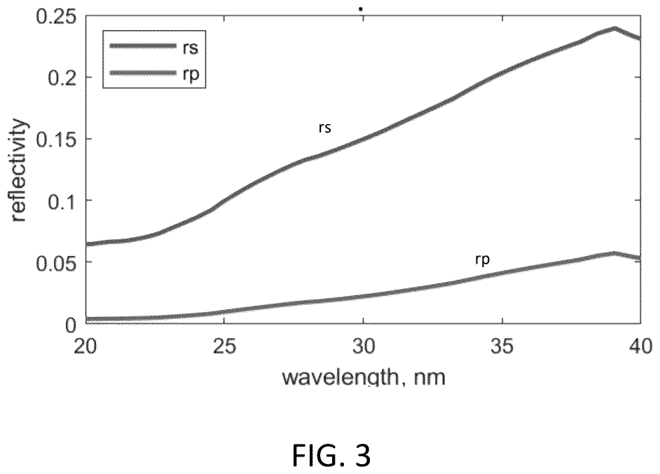

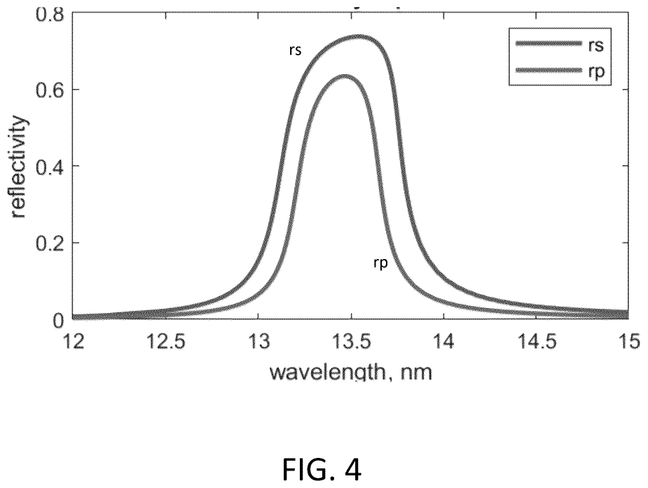

Light can change polarization after being reflected by the mirrors. Two examples with an Au film and Mo/Si multilayer mirror are shown. FIG. 3 shows an Au film with an angle of incidence of 45 degrees. FIG. 4 shows Si/Mo 200 pairs with a period of 7.5 nm and angle of incidence of 68 degrees.

In another example, the rotating elements include a transmissive phase retarder or a reflective phase retarder. These can include, for example, a chirped multi-layer mirror, one or more thin films, or other components. The difference phase of s-polarized light (rs) and p-polarized light (rp) also introduce a phase retardance when light is reflected. Unlike a polarizer, it is possible to fabricate a transmission-based phase retarder and a reflection-based phase retarder. An example of chirped Mo/Si multilayer mirrors as a reflective phase retarder is disclosed herein. “Chirped” means the bilayer periods are designed to linearly increase from top to bottom. In an example, there are thirteen pairs of Si/Mo layers with a center periodicity of 14.7 nm and a photon energy 90 cV. Delta_d means the periodicity is different from center to top (or bottom). In an example of thin-films as a reflective phase retarders, SnTe/Al₂O₃/Al trilayer or Al₂O₂/Al bilayer can be used with a photon wavelength of 121.6 nm.

Other elements can be positioned in the path of the radiation. In an embodiment, a fixed reflective polarizer can be positioned in the path of the scattering radiation. For example, a fixed reflective polarizer may be inserted right before the detector to reduce the effect of polarization dependence of the detector. In another embodiment, a rotating polarizer can be positioned in the path of the radiation, which is upstream of the workpiece. In another embodiment, a rotating analyzer can be positioned in a path of the scattering radiation, which is downstream of the workpiece. In another embodiment, a rotating compensator and a fixed analyzer can be positioned in a path of the spectral reflection and/or scattering radiation with a fixed polarizer and a rotating compensator positioned in in the path of the radiation. In another embodiment, an ellipsoidal mirror can be disposed in a path of the scattering radiation.

As shown in the embodiments herein, a processor 313 may be in electronic communication with one or more detectors, such as the detector 303 shown herein. The processor 313 may be configured to determine asymmetry-related critical dimensions from the scattering radiation and/or to determine XY-plan features from the polarization states. The processor 313 may be further configured to determine critical parameters of the workpiece from signals of the detector using machine learning, model-free techniques, or a regression engine. The regression engine may be configured to match the signals against simulated spectra at the critical parameters. All signal channels (various polarization states, various orders) can be simulated in a single simulation using solvers known in the art (e.g., distorted wave born approximation, rigorous coupled-wave analysis, finite element method, finite-difference time-domain, etc.).

The processor 313 is coupled to at least the detector(s), though the processor 313 also can be coupled with the radiation source or other components of the system. The processor 313 typically comprises a programmable processor, which is programmed in software and/or firmware to carry out the functions that are described herein, along with suitable digital and/or analog interfaces for connection to the other elements of the system. Alternatively or additionally, the processor 313 comprises hard-wired and/or programmable hardware logic circuits, which carry out at least some of the functions of the processor. Although the processor 313 is shown, for the sake of simplicity, as a single, monolithic functional block, in practice the processor 313 may comprise multiple, interconnected control units, with suitable interfaces for receiving and outputting the signals that are illustrated in the figures and are described in the text. Program code or instructions for the processor 313 to implement various methods and functions disclosed herein may be stored in readable storage media, such as a memory in the processor 313 or other memory.

For example, scattered orders can be used to extract the asymmetry-related critical dimensions, such as tilt, overlay, pitch walk, and aperiodicity. Polarization information can be used to extract XY-plane features, such as critical dimension, recess amount, side-wall angle, etc. Thus, the entire system provides improved sensitivity for semiconductor structures that measure both sets of parameters.

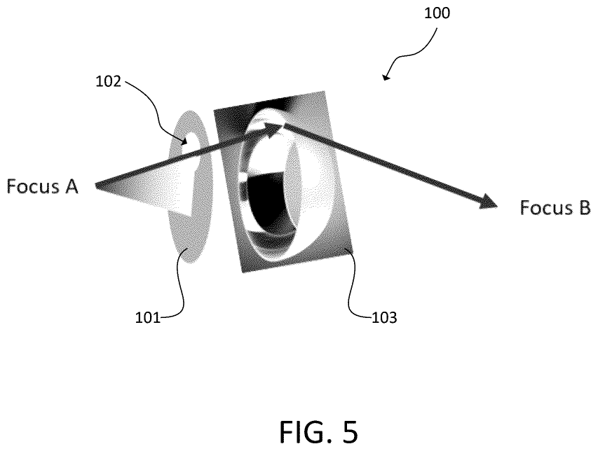

In FIG. 5, a wide numerical aperture source emits radiation to all direction from a focus point (“Focus A”) in the system 100. A rotating plate 101 in the path of the radiation (e.g., light) blocks most of the directions of radiation except for a pinhole 102 that lets the radiation pass through. As the rotating plate 101 is rotated, such as using an actuator, radiation passes through the pinhole 102, lands on different locations on the hollow ellipsoidal mirror 103, is reflected, and exits from the other side of the ellipsoidal mirror 103 to the other focus point (“Focus B”).

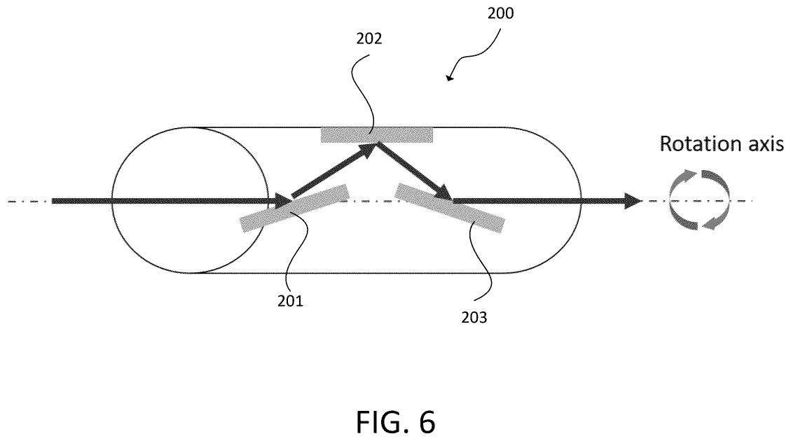

In FIG. 6, a narrow numerical aperture source emits radiation into the center of a rotating tube 200 that is in a path of the radiation (i.e., light). A motor or actuator can be used to rotate the tube 200. After three reflections (i.e., mirror 201, mirror 202, and mirror 203), the radiation is emitted out the rotating tube 200 from the center. In the embodiments disclosed herein, the incoming and outbound radiation may be on a same axis. The mirror 201, mirror 202, and mirror 203 in the rotating tube 200 can be Au/Pt or other reflective mirrors disclosed herein.

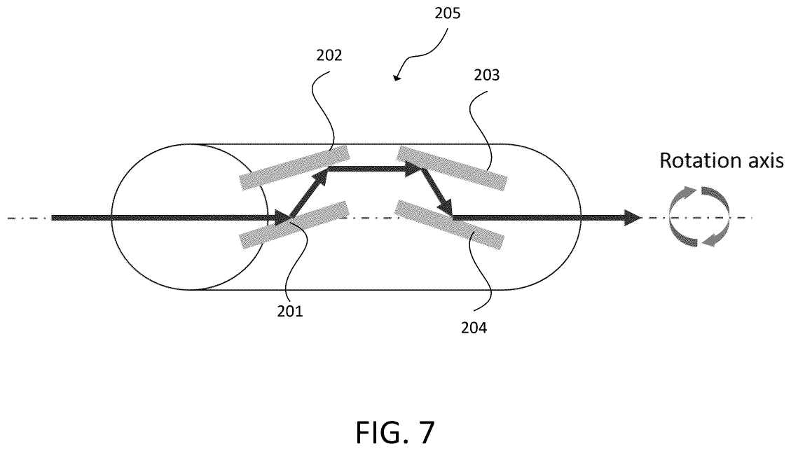

In FIG. 7, a narrow numerical aperture source emits radiation into the center of a rotating tube 205 that is in a path of the radiation (e.g., light). After four reflections (i.e., mirror 201, mirror 202, mirror 203, and mirror 204), the radiation is emitted out the rotating tube 205 from the center. Four reflections may sacrifice some intensity, but four reflections may be more symmetric and potentially more stable when rotating. In the embodiments disclosed herein, the incoming and outbound radiation may be on a same axis. The mirror 201, mirror 202, mirror 203, and mirror 204 in the rotating tube 205 can be Au/Pt or other reflective mirrors disclosed herein.

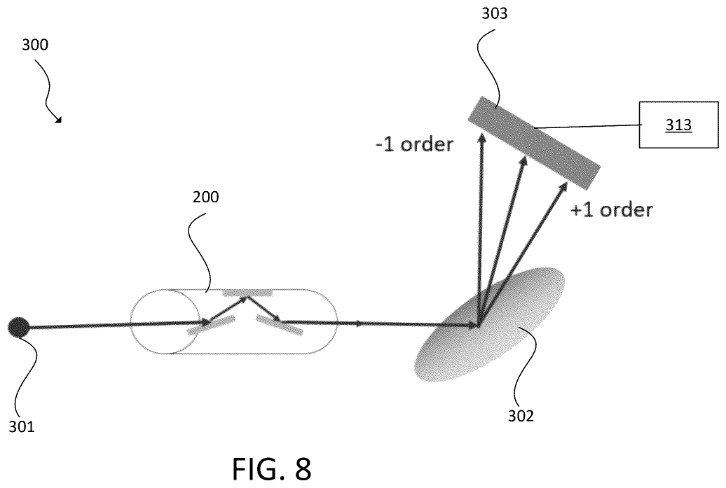

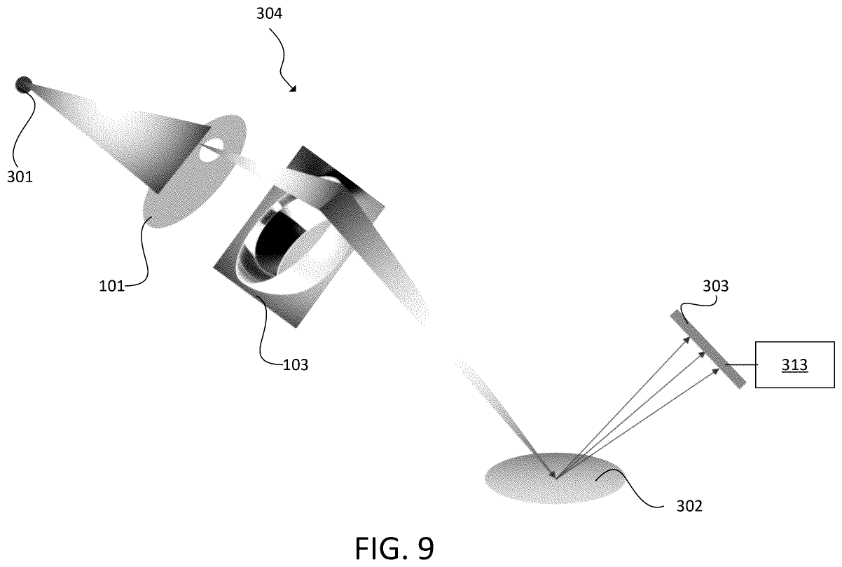

System architectures for system 300 and system 304 are shown in FIG. 8 and FIG. 9. The systems 300, 304 include rotating polarizer ellipsometric scatterometry (RPES). While shown with three reflections in the rotating tube 200 in FIG. 8, four reflections like in rotating tube 205 can be used. The number of reflections may be selected based on, for example, the radiation emitted from the radiation source or the type of radiation source. RPES gives two harmonics α and β, which can be used to extract tan Ψ and cos Δ for all scattering orders. Those two terms give the relative phase information between s and p polarization because rp/rs-tan Ψ(cos Δ+i sin Δ). Ψ may represent a difference in phases. When a broadband source is used as the radiation source 301, 0th orders of all wavelengths land at the same location on the detector 303 (i.e., they all overlap). A grating can be inserted between the workpiece 302 and the detector 303 to further split out different wavelengths in the 0th order. For all non-0th orders, different wavelengths will be scattered into different locations on the detector 303. A single wavelength laser source or single wavelength wide numerical aperture source may be used as the radiation source 301. The system architecture of FIG. 8 and FIG. 9 both provide the desired performance, but the particular architecture may be selected depending on, for example, whether the radiation source 301 has a broad numerical aperture or a narrow numerical aperture.

The detector 303 may have a polarization dependence. Alternatively, a fixed polarizer can be inserted between the workpiece 302 and the detector 303 to control the exit beam polarization state (rotating polarizer fixed analyzer ellipsometry). The fixed polarizer does not rotate.

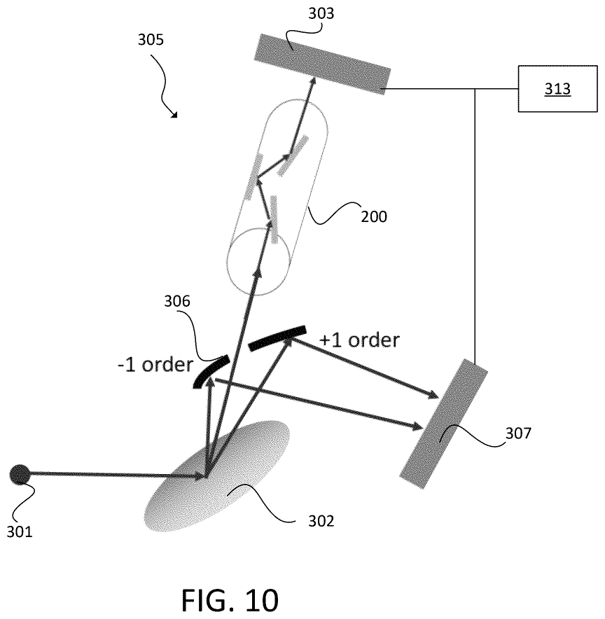

Another system architecture is shown in FIG. 10. The system 305 includes rotating analyzer ellipsometric scatterometry (RAES). While shown in three reflections with the rotating tube 200 in FIG. 10, four reflections like in rotating tube 205 can be used. The number of reflections may be selected based on, for example, the radiation emitted from the radiation source 301 or the type of radiation source 301. RAES gives same information as RPSE, but only for 0th order. For higher scattering orders, a mirror 306 is used to redirect them to a second detector 307 with intensity only. For a radiation source 301 that is a single-wavelength source, only the second detector 307 needs to be an array detector. For a radiation source 301 that is a broadband source, a grating can be inserted between the workpiece 302 and the detector 303 to spread 0th order into different directions. In this case, both the detector 303 and the second detector 307 may be an array detector.

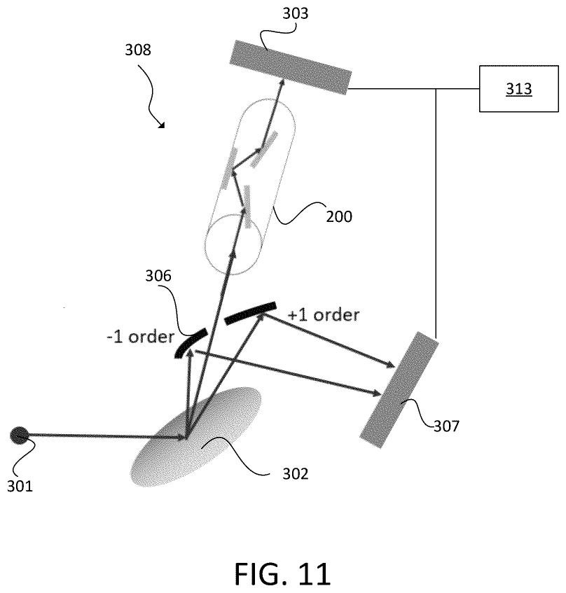

Another system architecture is shown in FIG. 11. The system 308 includes rotating compensator ellipsometric scatterometry (RCES). While shown with three reflections in the rotating tube 200 in FIG. 10, four reflections like in rotating tube 205 can be used. The number of reflections may be selected based on, for example, the radiation emitted from the radiation source 301 or the type of radiation source 301. RCES gives S1, S2 and S3 Stokes parameters, whereas RPSE/RASE only gives S1 and S2. Four sets of harmonics can be obtained instead of two. This extra information is provided for the 0th order. High orders remain intensity only.

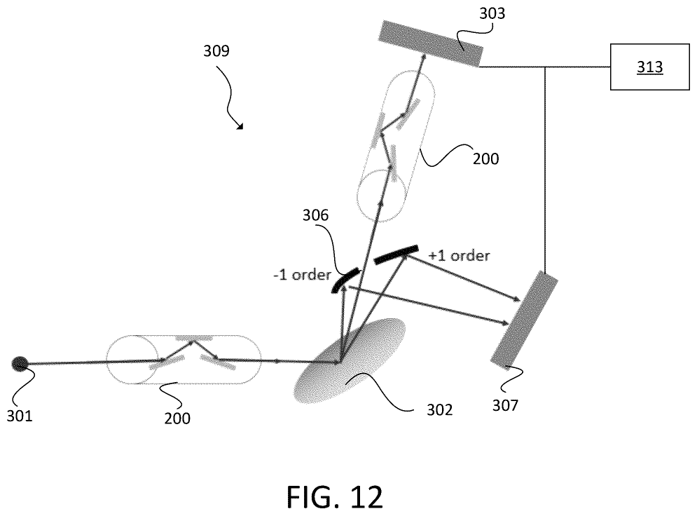

Another system architecture is shown in FIG. 12. The system 309 includes rotating compensator ellipsometric scatterometry (RCRCES). While shown with three reflections in the rotating tube 200 in FIG. 10, four reflections like in rotating tube 205 can be used. The number of reflections may be selected based on, for example, the radiation emitted from the radiation source 301 or the type of radiation source 301. At least one of the rotating tubes 200 (such as the rotating tube 200 between the radiation source 301 and the workpiece 302) can serve as a polarizer and rotating compensator. RCRCES gives full Mueller for 0th order and tan Ψ and cos Δ for scattering orders. This system 309 provides more information to resolve the sample structures on the workpiece 302 than the embodiments of FIGS. 8-11.

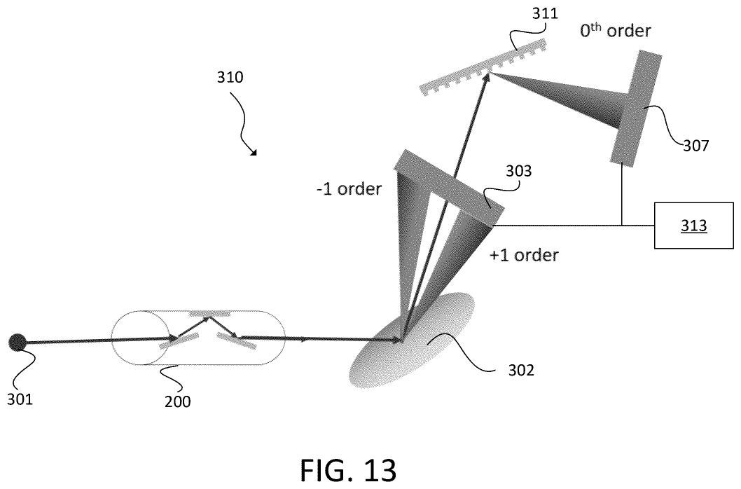

Another system architecture is shown in FIG. 13. A broadband laser like source RPES can be used with a grating 311 that spreads the 0th order into different directions based on wavelengths. The grating 311 may be a diffraction grating that divides (i.e., disperses) radiation with multiple different wavelengths (e.g., white light) into light components by wavelength. The configuration may be like that of FIG. 8, but the 0th order is received by a second detector 307.

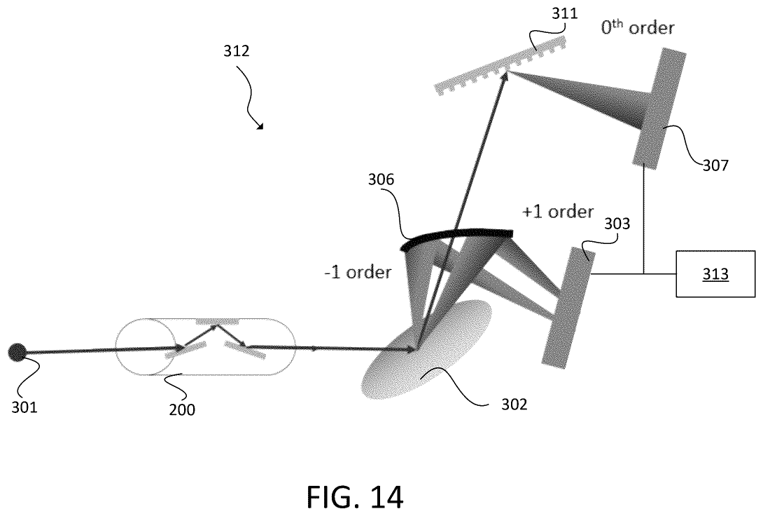

Another system architecture is shown in FIG. 14. The system 312 includes an ellipsoidal mirror 306 compared to FIG. 13. A broadband laser like source RPES also can be used.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A system comprising:
a radiation source that generates radiation having at least one wavelength from 0.1 to 100 nm;
one or more rotating elements configured to change polarization of the radiation and/or relative phase between two polarizations of the radiation;
a stage configured to hold a workpiece in a path of the radiation; and
at least one detector that receives spectral reflection and scattering radiation from the workpiece.

2. The system of claim 1, wherein the radiation source is a narrow-band source.

3. The system of claim 2, wherein the narrow-band source is a wide numerical aperture plasma source.

4. The system of claim 2, wherein the narrow-band source is a narrow numerical aperture laser-like source.

5. The system of claim 1, wherein the radiation source is a broadband source.

6. The system of claim 1, wherein the rotating elements include a reflective polarizer.

7. The system of claim 6, wherein the reflective polarizer is disposed in a path of the spectral reflection between the workpiece on the stage and the detector.

8. The system of claim 1, wherein the rotating elements include a transmissive phase retarder.

9. The system of claim 1, wherein the rotating elements include a reflective phase retarder.

10. The system of claim 1, further comprising a rotating polarizer in the path of the radiation.

11. The system of claim 1, further comprising a rotating analyzer in a path of the scattering radiation.

12. The system of claim 1, further comprising a rotating compensator and a fixed analyzer in a path of the scattering radiation.

13. The system of claim 12, further comprising a fixed polarizer and a rotating compensator in the path of the radiation.

14. The system of claim 1, further comprising a fixed reflective polarizer in the path of the scattering radiation.

15. The system of claim 1, further comprising a processor in electronic communication with the detector, wherein the processor is configured to determine asymmetry-related critical dimensions from signals of the detector.

16. The system of claim 1, further comprising a processor in electronic communication with the detector, wherein the processor is further configured to determine XY-plan features from polarization states.

17. The system of claim 16, wherein the processor is further configured to determine critical parameters of the workpiece from signals of the detector using machine learning.

18. The system of claim 16, wherein the processor is further configured to determine critical parameters of the workpiece from signals of the detector using a regression engine, and wherein the regression engine is configured to match the signals against simulated spectra at the critical parameters.

19. The system of claim 1, further comprising a plurality of the detectors to receive the spectral reflection and/or the scattering radiation.

20. The system of claim 1, further comprising an ellipsoidal mirror disposed in a path of the spectral reflection.

21. The system of claim 1, wherein the radiation includes a wavelength at 13.5 nm.
